(19) United States
(12) Patent Application Publication
(10) Pub. No.: US 2014/0353292 A1
(43) Pub. Date: Dec. 4, 2014

(54) SYSTEMS AND METHODS FOR SPOT WELDING USING ELECTRODE TIPS

(71) Applicants: Robert Daniel Anderzack, Raymond, OH (US); Thomas Edward Fischer, Marysville, OH (US); Daniel James Brewbaker, Delaware, OH (US); Herbert D. Schrader, Rushsylvania, OH (US); Gregory A. Jolliff, Kenton, OH (US)

(72) Inventors: Robert Daniel Anderzack, Raymond, OH (US); Thomas Edward Fischer, Marysville, OH (US); Daniel James Brewbaker, Delaware, OH (US); Herbert D. Schrader, Rushsylvania, OH (US); Gregory A. Jolliff, Kenton, OH (US)

(73) Assignee: HONDA MOTOR CO., LTD., Tokyo (JP)

(21) Appl. No.: 13/907,257

(22) Filed: May 31, 2013

(51) Int. Cl. B23K 11/30; B23K 11/11

(52) U.S. Cl. CPC B23K 11/3018; B23K 11/115; B23K 11/3009
USPC 219/91.2; 219/119; 219/120

(57) ABSTRACT

A cold-formed electrode tip for use in spot welding is provided. The cold-formed electrode tip includes a base, a rounded face, and an annular wall extending along a longitudinal axis of the electrode tip, the annular wall having a thickness such that the annular wall is configured to be readily deformed by a handheld tool.

### BACKGROUND

The field of the disclosure relates generally to spot welding, and more specifically, to electrode tips for use with a weld gun.

Spot welding is used to join various workpieces. More specifically, spot welding is a resistance welding technique that operates by applying a welding current and a clamping force to a relatively small area of the parts to be welded. By concentrating the welding current and force, heat generated by the welding current melts the parts at the welding spot, joining them to one another upon removal of the welding current and cooling of the parts.

Spot welding requires sufficient current to melt the materials to be joined and also requires that sufficient pressure be exerted to maintain contact between the parts at the welding spot during the application of the welding current. To this end, various spot welding devices have been designed and used. At least some known spot welding devices include a spot welding gun with electrode tips mounted on opposing gun arms. Clamping pressure is provided by moving one or both of the gun arms relative to each other. Electric current is passed from one electrode tip to the other. Resistance to the transfer of electric current causes a buildup of heat, which temporarily melts the parts at the welding spot and leads to their joining.

Over time, electrode tips wear down and eventually require replacement. In at least some known spot welding systems, electrode tips wear down relatively quickly and must be replaced relatively often (e.g., four times a day). Further, depending on the dimensions and/or composition of the electrode tips, substantial torque may be required to remove an exhausted electrode tip from a spot welding gun. Moreover, at least some known electrode tips are fully machined components, making them relatively expensive to manufacture.

### BRIEF DESCRIPTION

In one aspect, a cold-formed electrode tip for use in spot welding is provided. The cold-formed electrode tip includes a base, a rounded face, and an annular wall extending along a longitudinal axis of the electrode tip, the annular wall having a thickness such that the annular wall is configured to be readily deformed by a handheld tool.

In another aspect, an electrode tip assembly for use in spot welding is provided. The electrode tip assembly includes a shank, and a cold-formed electrode tip inserted partially within the shank such that a portion of the cold-formed electrode tip remains exposed. The cold-formed electrode tip includes a base, a rounded face, and an annular wall extending along a longitudinal axis of the cold-formed electrode tip, the annular wall configured to be readily deformed by a handheld tool to facilitate removing the cold-formed electrode tip from the shank.

In yet another aspect, a method for spot welding a first workpiece to a second workpiece is provided. The method includes positioning the first workpiece and the second workpiece between a first electrode tip and a second electrode tip, wherein the first and second electrode tips each include a base, a rounded face, and an annular wall extending along a longitudinal axis of the respective electrode tip, the annular wall having a thickness such that the annular wall is configured to be readily deformed by a handheld tool. The method further includes applying a clamping force to the first and second workpieces, and generating a welding current through the first and second electrode tips to form a weld between the first and second workpieces.

The features, functions, and advantages that have been discussed can be achieved independently in various embodiments or may be combined in yet other embodiments, further details of which can be seen with reference to the following description and drawings.

### BRIEF DESCRIPTION OF THE DRAWINGS

FIG. 1 is a perspective view of an exemplary weld gun.

FIG. 2 is a schematic view of an exemplary spot welding process using the weld gun shown in FIG. 1.

FIG. 3 is a perspective view of an exemplary electrode tip assembly that may be used with the weld gun shown in FIG. 1.

FIG. 4 is a schematic diagram of an exemplary tip that may be used with the weld gun shown in FIG. 1.

FIG. 5 is a flowchart of an exemplary method for spot welding workpieces.

### DETAILED DESCRIPTION

The methods and systems described herein facilitate spot welding using an electrode tip assembly. An electrode tip includes a relatively thin annular wall that facilitates deforming the electrode tip to expedite removal and replacement. Further, the electrode tip described herein includes a relatively wide cooling hole to facilitate cooling the electrode tip during a welding process. Moreover, to facilitate reducing manufacturing costs, the electrode tip described herein is cold-formed, as opposed to being a fully machined component.

As used herein, an element or step recited in the singular and proceeded with the word “a” or “an” should be understood as not excluding plural elements or steps unless such exclusion is explicitly recited. Furthermore, references to “one embodiment” of the present invention or the “exemplary embodiment” are not intended to be interpreted as excluding the existence of additional embodiments that also incorporate the recited features.

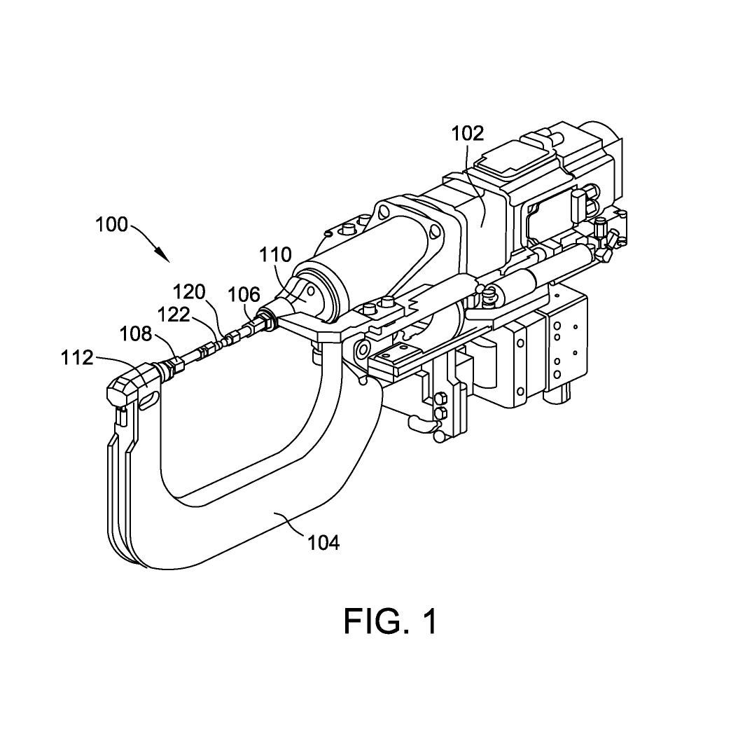

FIG. 1 is a perspective view of an exemplary weld gun 100 for spot welding workpieces to one another. Weld gun 100 may be, for example, a servo-operated weld gun. In the exemplary embodiment, weld gun 100 includes a main body 102 coupled to a C-arm 104. A first electrode tip assembly 106 extends from main body 102, and a second electrode tip assembly 108 extends from C-arm 104 towards first electrode tip assembly 106. Workpieces that are to be welded to each other are positioned between first and second electrode tip assemblies 106 and 108, as described in detail herein.

To accommodate workpieces, first and second electrode tip assemblies 106 and 108 are moveable relative to each other. In the exemplary embodiment, first and second electrode tip assemblies 106 and 108 are moveable linearly towards and away from each other. Further, first electrode tip assembly 106 is pivotable about a first pivot point 110 and second electrode tip assembly 108 is pivotable about a second pivot point 112. Alternatively, first and second tip assemblies 106 and 108 may be movable relative to each other in any manner than enables weld gun 100 to function as described herein. In the exemplary embodiment, a servo motor (not shown) controls movement of first and second electrode tip assemblies 106 and 108 relative to one another. Alternatively, weld gun 100 may include any control device that enables weld gun 100 to function as described herein.

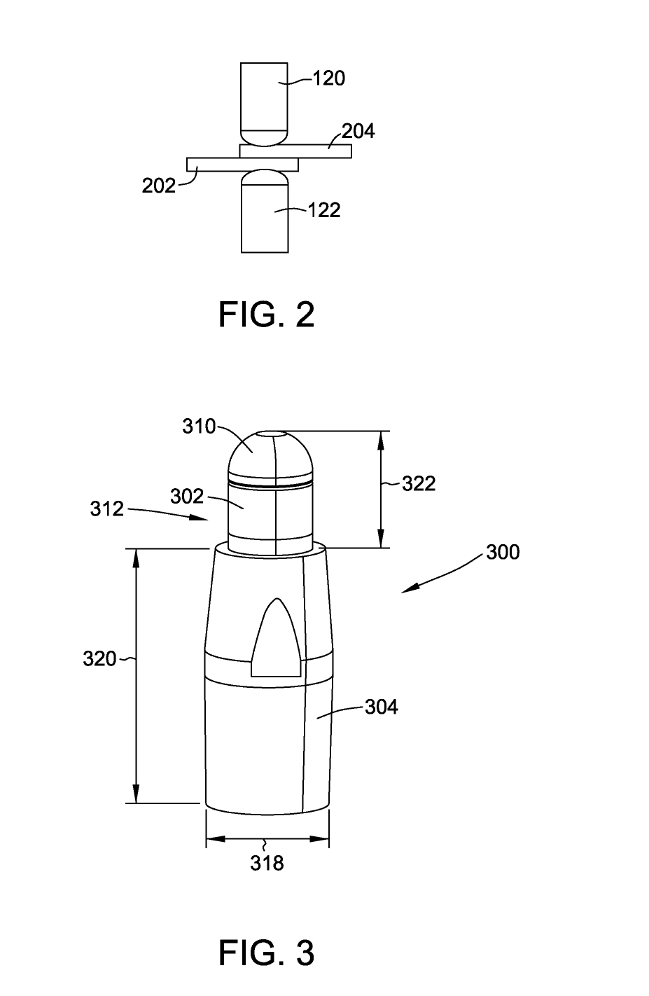

First electrode tip assembly 106 includes a first electrode tip 120, and second electrode tip assembly 108 includes a second electrode tip 122. As shown in FIG. 2, to weld a first workpiece 202 and a second workpiece 204, first and second workpieces 202 and 204 are positioned between first and second electrode tips 120 and 122. Weld gun 100 (shown in FIG. 1) applies a clamping force between first and second electrode tips 120 and 122 and applies a welding current to first and second electrode tips 120 and 122. The welding current melts at least a portion of first and second workpieces 202 and 204, and the clamping force pushes first and second workpieces 202 and 204 against each other to form a weld. In the exemplary embodiment, weld gun 100 can provide a clamping force of up to approximately 550 kilogram-force (kgf). Alternatively, weld gun 100 may provide any clamping force that enables weld gun 100 to function as described herein.

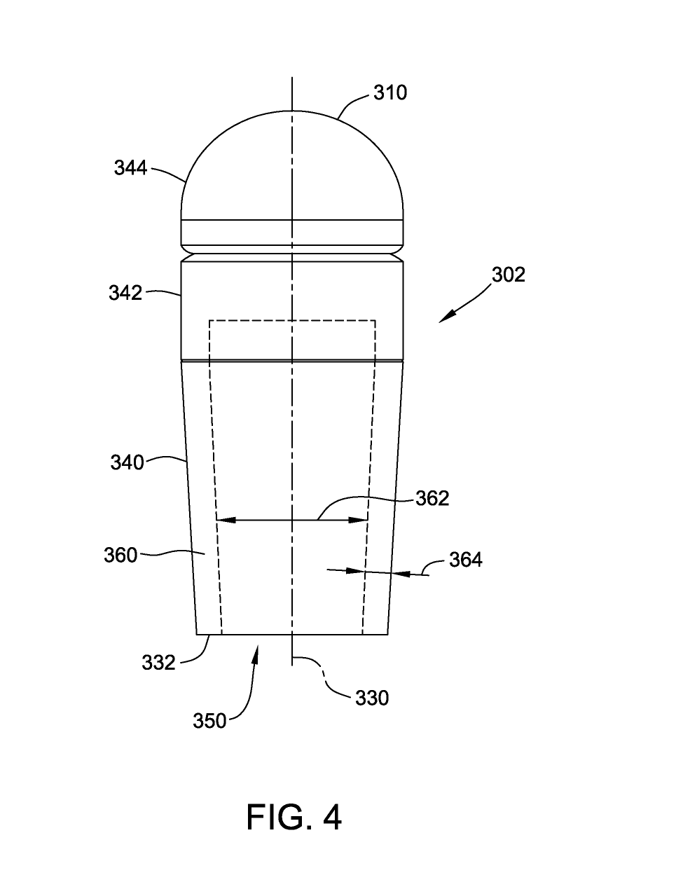

FIG. 3 is a perspective view of an exemplary electrode tip assembly 300 that may be used with weld gun 100 (shown in FIG. 1). Electrode tip assembly 300 may be, for example, first electrode tip assembly 106 and/or second electrode tip assembly 108 (both shown in FIGS. 1 and 2). Electrode tip assembly 300 includes an electrode tip 302 that extends partially within a shank 304. FIG. 4 is a schematic view of electrode tip 302.

Electrode tip 302 includes a rounded face 310 that forms part of an exposed portion 312 of electrode tip 302. Over the course of a plurality of welding operations, rounded face 310 is partially consumed and becomes flattened, at which point a new rounded face 310 may be cut on electrode tip 302. Eventually, a majority of electrode tip 302 is consumed, and electrode tip 302 must be replaced. To replace electrode tip 302, a tool (e.g., a tip wrench) is used to grip and remove electrode tip 302 from shank 304. A replacement electrode tip 302 is partially inserted within shank 304 and struck using a tool (e.g., a hammer) to secure replacement electrode tip 302 within shank 304.

The longer the exposed portion 312 of electrode tip 302, the less often electrode tip 302 needs to be replaced. More specifically, with a longer exposed portion 312, more of electrode tip 302 can be consumed during welding. A diameter 138 of shank 304 in some embodiments is from approximately 15 millimeters (mm) to 25 mm, or more specifically from approximately 8 mm to 22 mm, and still more specifically approximately 20 mm. Further, a height 320 of shank 304 in some embodiments is from approximately 45 mm to 55 mm, or more specifically from approximately 48 mm to 52 mm, and still more specifically approximately 50 mm. In the exemplary embodiment, shank 304 has a diameter 318 of approximately 20 mm and a height 320 of approximately 50 mm. Accordingly, if electrode tip 302 has a total length of 38.5 mm, and 16 mm are within shank 304, an exposed length 322 of electrode tip 302 is approximately 22.5 mm. A shank height 320 of approximately 50 mm is less than heights of at least some known shanks, increasing the exposed length 322 of electrode tip 302. Accordingly, electrode tip assembly 300 facilitates a longer use and/or fewer replacements of electrode tip 302 than at least some known electrode tip assemblies.

In the exemplary embodiment, electrode tip 302 is formed using a cold forming process in which a slug of material is stamped into a die to form electrode tip 302. Electrode tip 302 is Class I Copper Zirconium (CuZr) in the exemplary embodiment. Alternatively, electrode tip 302 may be formed from any suitable material and using any suitable methods that enables electrode tip 302 to function as described herein.

As shown in FIG. 4, electrode tip 302 extends along a longitudinal axis 330 from a base 332 to rounded face 310. More specifically, electrode tip 302 includes a base portion 340, a cylindrical intermediate portion 342, and a face portion 344. A cooling hole 350 is formed within electrode tip 302, and extends through base portion 340 and at least partially through intermediate portion 342.

Cooling hole 350 defines an annular wall 360 of electrode tip 302. As shown in FIG. 4, in the exemplary embodiment, cooling hole 350 and annular wall 360 both taper outwardly along longitudinal axis 330 from base 332 towards intermediate portion 342. During a welding operation, cooling hole 350 is filled with a cooling fluid (e.g., water) to facilitate cooling electrode tip 302. A diameter 362 of cooling hole 350 in some embodiments is larger than 2 mm, or more specifically larger than 6 mm, and still more specifically larger than 8 mm. A thickness 364 of annular wall 360 in some embodiments is from approximately 0 mm to 10 mm, or more specifically from approximately 0 mm to 5 mm, and still more specifically approximately 2 mm. Alternatively, cooling hole 350 and/or annular wall 360 may have any dimensions that enable electrode tip 302 to function as described herein.

As annular wall 360 is relatively thin, annular wall 360 is readily deformable using a handheld tool (e.g., a tip wrench). More specifically, in the exemplary embodiment, annular wall 360 is thick enough to withstand axial forces (i.e., forces along longitudinal axis 330) during a welding operation, yet thin enough to deform under radial forces (i.e., forces orthogonal to longitudinal axis 330) applied by a handheld tool, such as a handheld tip wrench. Accordingly, electrode tip 302 may be removed from shank 304 more easily than an electrode tip that cannot be deformed with a handheld tool. More specifically, as compared to at least some known electrode tips, less torque may be required to grip and remove electrode tip 302. Further, as compared to electrode tips having thicker walls, relatively thin annular wall 360 increases a current density in electrode tip 302 when the welding current is applied.

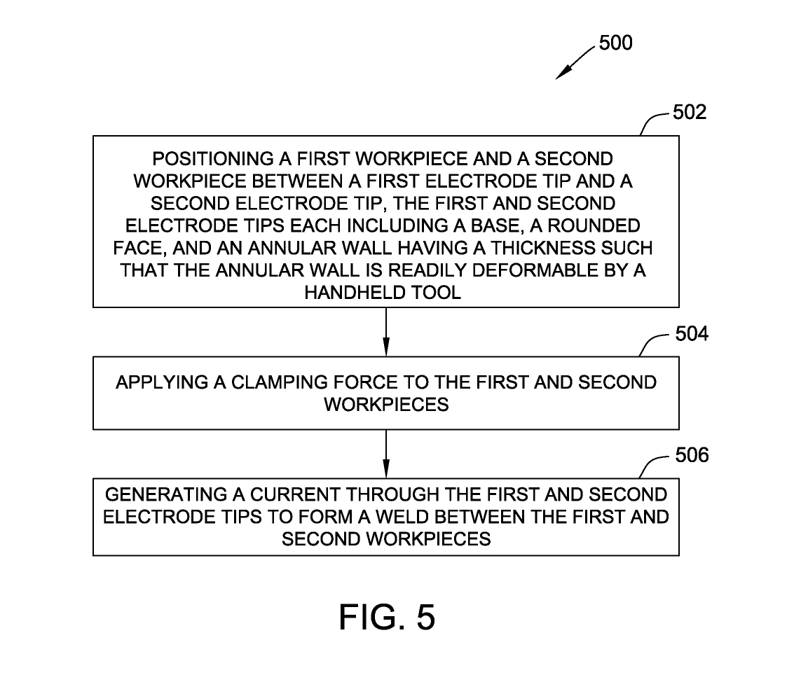

FIG. 5 is a flowchart of an exemplary method 500 for use in welding a first workpiece to a second workpiece, such as first and second workpieces 202 and 204 (both shown in FIG. 2). The first workpiece and the second workpiece are positioned 502 adjacent one another between a first electrode tip and a second electrode tip, such as first electrode tip 120 and second electrode tip 122 (both shown in FIG. 2). First and second electrode tips each include a base, such as base 332, a rounded face, such as rounded face 310, and an annular wall extending along a longitudinal axis of the respective electrode tip, such as annular wall 360 (all shown in FIG. 3). The annular wall has a thickness such that the annular wall may be readily deformed by a handheld tool, such as a tip wrench. A clamping force is applied 504 to the first and second workpieces by compressing the first and second workpieces between the first and second electrode tips. To form the weld, a welding current is generated 506 through the first and second electrode tips.

The embodiments described herein facilitate spot welding using an electrode tip assembly. An electrode tip includes a relatively thin annular wall that facilitates deforming the electrode tip to expedite removal and replacement. Further, the electrode tip described herein includes a relatively wide cooling hole to facilitate cooling the electrode tip during a welding process. Moreover, to facilitate reducing manufacturing costs, the electrode tip described herein is cold-formed, as opposed to being a fully machined component.

As compared to at least some known electrode tips, the electrode tips described herein have a relatively thin, deformable annular wall, requiring less torque for removal from a shank. Further, as compared to at least some known electrode tips that are fully machined, the electrode tips described herein are cold-formed, reducing manufacturing costs. Moreover, the electrode tip assemblies described herein include a shorter shank than at least some known electrode tip assemblies. This allows for more of the electrode tip to be exposed, enabling the electrode tip to last longer before requiring replacement.

Exemplary embodiments of tip assemblies for use in spot welding are described above in detail. The systems and methods are not limited to the specific embodiments described herein, but rather, components of the systems and/or steps of the methods may be utilized independently and separately from other components and/or steps described herein. For example, the systems may also be used in combination with other manufacturing systems and methods, and are not limited to practice with only the manufacturing systems and methods as described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A cold-formed electrode tip for use in spot welding, said cold-formed electrode tip comprising:
a base;
a rounded face; and
an annular wall extending along a longitudinal axis of said electrode tip, said annular wall having a thickness such that said annular wall is configured to be readily deformed by a handheld tool.

2. A cold-formed electrode tip in accordance with claim 1, wherein said cold-formed electrode tip is Class I Copper Zirconium.

3. A cold-formed electrode tip in accordance with claim 1, wherein said annular wall defines a cooling hole extending partially through said cold-formed electrode tip, said cooling hole having a diameter larger than 8 millimeters.

4. A cold-formed electrode tip in accordance with claim 1, wherein said annular wall has a thickness of approximately 2 millimeters.

5. A cold-formed electrode tip in accordance with claim 1, wherein said annular wall extends from said base towards said rounded face.

6. A cold-formed electrode tip in accordance with claim 1, wherein said annular wall tapers outward from said base towards said rounded face.

7. An electrode tip assembly for use in spot welding, said electrode tip assembly comprising:
a shank; and
a cold-formed electrode tip inserted partially within said shank such that a portion of said cold-formed electrode tip remains exposed, said cold-formed electrode tip comprising:
a base;
a rounded face; and
an annular wall extending along a longitudinal axis of said cold-formed electrode tip, said annular wall configured to be readily deformed by a handheld tool to facilitate removing said cold-formed electrode tip from said shank.

8. An electrode tip assembly in accordance with claim 7, wherein said shank has a height of approximately 50 millimeters.

9. An electrode tip assembly in accordance with claim 7, wherein said exposed portion of said cold-formed electrode tip has a length of approximately 22.5 millimeters.

10. An electrode tip assembly in accordance with claim 7, wherein said cold-formed electrode tip is Class I Copper Zirconium.

11. An electrode tip assembly in accordance with claim 7, wherein said annular wall defines a cooling hole extending partially through said cold-formed electrode tip, said cooling hole having a diameter larger than 8 millimeters.

12. An electrode tip assembly in accordance with claim 7, wherein said annular wall has a thickness of approximately 2 millimeters.

13. An electrode tip assembly in accordance with claim 7, wherein said annular wall extends from said base towards said rounded face.

14. An electrode tip assembly in accordance with claim 7, wherein said annular wall tapers outward from said base towards said rounded face.

15. A method for spot welding a first workpiece to a second workpiece, said method comprising:
positioning the first workpiece and the second workpiece between a first electrode tip and a second electrode tip, wherein the first and second electrode tips each include a base, a rounded face, and an annular wall extending along a longitudinal axis of the respective electrode tip, the annular wall having a thickness such that the annular wall is configured to be readily deformed by a handheld tool;
applying a clamping force to the first and second workpieces; and
generating a welding current through the first and second electrode tips to form a weld between the first and second workpieces.

16. A method in accordance with claim 15, further comprising deforming the annular wall of at least one of the first and second electrode tips using a tip wrench.

17. A method in accordance with claim 15, wherein positioning the first and second workpieces comprises positioning the first and second workpieces between first and second electrode tips each including an annular wall with a thickness of approximately 2 millimeters.

18. A method in accordance with claim 15, wherein applying a clamping force comprises applying a clamping force of approximately 550 kilogram-force.

19. A method in accordance with claim 15, further comprising supplying a cooling fluid to a cooling hole defined in each of the first and second electrode tips, each cooling hole having a diameter greater than 8 millimeters.

20. A method in accordance with claim 15, further comprising cold-forming at least one of the first and second electrode tips from Class I Copper Zirconium.
